(19) United States
(12) Patent Application Publication
(10) Pub. No.: US 2025/0142499 A1
(43) Pub. Date: May 1, 2025

(54) SYSTEMS AND METHODS FOR TRANSMITTING ON-DEMAND MESSAGE FOR IDLE USER EQUIPMENT

(71) Applicant: Samsung Electronics Co., Ltd., Suwon-si (KR)

(72) Inventors: Liang HU, San Diego, CA (US); Philippe Jean Marc Michel SARTORI, Naperville, IL (US)

(21) Appl. No.: 18/932,497

(22) Filed: Oct. 30, 2024

Related U.S. Application Data
(60) Provisional application No. 63/546,678, filed on Oct. 31, 2023.
(60) Provisional application No. 63/549,228, filed on Feb. 2, 2024.
(60) Provisional application No. 63/567,270, filed on Mar. 19, 2024.

(51) Int. Cl. H04W 56/00; H04L 5/00; H04W 52/02; H04W 68/02

(52) U.S. Cl. CPC H04W 56/0015; H04L 5/0051; H04W 52/0235; H04W 68/02

(57) ABSTRACT

A system and a method are disclosed for reducing power consumption in cell selection/reselection. The method includes transmitting, to a network node by the UE, a wake-up signal (WUS) in response to a trigger condition, receiving, from the network node by the UE, a confirmation message of a receipt of the WUS, and receiving an on-demand message via a Synchronization Signal Block (SSB) or a System Information Block Type 1 (SIB1) within a time window.

### CROSS-REFERENCE TO RELATED APPLICATION

The present application claims priority to and the benefit under 35 U.S.C. § 119 (c) of U.S. Provisional Application No. 63/546,678, filed on Oct. 31, 2023, entitled “ON-DEMAND SIB1/SSB AND PAGING FOR IDLE/INACTIVE UES IN NES,” U.S. Provisional Application No. 63/549,228, filed on Feb. 2, 2024, entitled “ON-DEMAND SIB1/SSB AND PAGING FOR IDLE/INACTIVE UES IN NES,” and U.S. Provisional Application No. 63/567,270, filed on Mar. 19, 2024, entitled “ON-DEMAND SIB1/SSB AND PAGING FOR IDLE/INACTIVE UES IN NES,” their entire disclosures of which are incorporated by reference herein.

### TECHNICAL FIELD

Aspects of some embodiments relate to wireless communications. For example, aspects of some embodiments of the present disclosure relate to improvements to transmitting on-demand message for user equipments (UEs) in idle/inactive mode.

### SUMMARY

Modern communications equipment (e.g., mobile phones, vehicles, laptops, satellites, and the like), also known as UE, may communicate with a network node (e.g., a gNB) to receive data from a network associated with the network node and to transmit data to the network associated with the network node. The UE may periodically receive System Information Block 1 (SIB1) which provides information for random access, scheduling SIB (e.g., SIB1, SIB3, SIB4, and/or the like) transmissions and cell camping. However, this type of periodical transmission may increase power consumption, especially when the transmission is unnecessary. For example, the network node may still transmit legacy SIB1 when there is no UEs in its cell. Due to the deployment of cellular systems that is towards denser networks, larger operating bandwidths, and the use of large number of antennas, a need to reduce power consumption of cellular networks is desired.

According to some embodiments of the present disclosure, a method for performing an on-demand wake-up procedure includes receiving, from a network node by a UE in idle or inactive mode, a Synchronization Signal Block (SSB), transmitting, to the network node by the UE, a WUS in response to the SSB, and receiving an on-demand message via a second SSB or a System Information Block Type 1 (SIB1) within a time window in a search space.

In some embodiments, the method may further include receiving, from a second network node by the UE, configuration information of the WUS and configuration information of the reference signal.

In some embodiments, the WUS may be an uplink (UL) wake-up signal transmitted in a time slot which is overlapped or before a downlink (DL) paging frame.

In some embodiments, the WUS may be transmitted in a first DL paging frame n to trigger the on-demand message in a second DL paging frame n+31.

In some embodiments, the WUS may be transmitted before the DL paging frame to trigger the on-demand message in a third DL paging frame n.

In some embodiments, the reference signal may be a light reference signal which comprises at least one of Primary Synchronization Signal (PSS) or Secondary Synchronization Signal (SSS).

In some embodiments, the method may further include receiving, from the network node by the UE, a confirmation message of a receipt of the WUS.

In some embodiments, the search space may be indicated in a previous on-demand message or the confirmation message.

In some embodiments, transmitting the WUS in response to the SSB is based on a trigger condition, where the trigger condition may be selected from among the group consisting of: a first trigger condition that either Srxlev is not higher than SintrasearchP or Squal is not higher than SintrasearchQ; a second trigger condition that a cell reselection is towards a higher priority inter-frequency or a higher priority inter-system layer; or a third trigger condition that Srxlev is higher than SnonintrasearchP and Squal is higher than SnonintrasearchQ.

In some embodiments, the time window may be indicated in the configuration information of WUS which includes a starting time and a duration of the time window.

According to some embodiments of the present disclosure, a UE for performing an on-demand wake-up procedure includes a processing circuit, where the processing circuit is configured to perform: receiving, from a network node, a Synchronization Signal Block (SSB), where the UE is in idle or inactive mode, transmitting, to the network node by the UE, a WUS in response to the SSB, and receiving an on-demand message via a second SSB or a System Information Block Type 1 (SIB1) within a time window in a search space.

According to other embodiments of the present disclosure, a system for performing an on-demand wake-up procedure includes a UE, where the UE is configured to receive, from a network node, a Synchronization Signal Block (SSB), where the UE is in idle or inactive mode; transmit, to the network node, a WUS in response to the SSB, where the UE is in idle or inactive mode, and receive an on-demand message via a second SSB or a System Information Block Type 1 (SIB1) within a time window in a search space.

### BRIEF DESCRIPTION OF THE DRAWINGS

The above and other aspects of the present disclosure will be more clearly understood from the following detailed description of the illustrative, non-limiting embodiments with reference to the accompanying drawings.

FIG. 1 is a diagram depicting a method for performing an on-demand wake-up procedure, according to some embodiments of the present disclosure.

FIG. 2 is a diagram depicting an example WUS transmission, according to some embodiments of the present disclosure.

FIG. 3 is a diagram depicting a second method for performing an on-demand wake-up procedure, according to some embodiments of the present disclosure.

FIG. 4 is a diagram depicting a method for performing an on-demand wake-up procedure, according to some embodiments of the present disclosure.

FIG. 5 is a diagram depicting an example light reference signal, according to some embodiments of the present disclosure.

FIG. 6 is a diagram depicting example trigger conditions for measurements, according to some embodiments of the present disclosure.

FIG. 7 is a diagram depicting an example of light reference signal transmitted within Light Reference Signal-based Radio Resource Measurement Timing Configuration (LMTC) window, according to some embodiments of the present disclosure.

FIG. 8 is a flowchart depicting a method for performing an on-demand wake-up procedure, according to some embodiments of the present disclosure.

FIG. 9 is a block diagram of an electronic device in a network environment, according to some embodiments of the present disclosure.

FIG. 10 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The electronic or electric devices and/or any other relevant devices or components according to embodiments of the present disclosure described herein may be implemented utilizing any suitable hardware, firmware (e.g., an application-specific integrated circuit (ASIC)), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Considering a growing development of denser networks, larger operating bandwidths, and larger number of antennas being utilized, there are higher demands to reduce power consumption in transmissions between UEs and network nodes. For example, SIB1 is frequently and periodically transmitted by the network node, even when SIB1 is not needed (e.g., there is no UEs in the cell). However, these signals (e.g., SIB1) are needed for the UEs to perform basic operations in RRC_IDLE mode and/or inactive mode (e.g., an initial access). Therefore, there is a need to enable the network node to limit the transmissions while still enabling the UE to perform idle/inactive mode procedures.

To overcome these issues, systems and methods are described herein for transmitting an on-demand message to a UE. For example, the UE may determine to send a wake-up signal (WUS) to a network node when a trigger event occurs (e.g., changing from the current camped cell to the candidate cell) in idle/inactive mode. The WUS may be utilized to trigger an on-demand message (e.g., SSB and/or SIB1) to be sent to the UE in a later paging frame on demand.

As described in more detail below, aspects of some embodiments of the present disclosure may enable reducing the amount of the transmitted SSB and SIB1 from the network node to the UE to avoid constantly assessing the quality of the currently camped cell and/or candidate cells. For example, the UE may transmit a WUS to the candidate cell, where the WUS may trigger an on-demand SSB/SIB1 from the candidate cell. Furthermore, the reference signals from the candidate/neighboring cells to the UE may be transmitted within a specific, periodic window (e.g., Light Reference Signal-based Radio Resource Measurement Timing Configuration (LMTC) window) to enhance a performance of cell selection/reselection.

The above approaches may enable reducing the power consumption and overhead involved in unnecessary transmissions of SSB/SIB1.

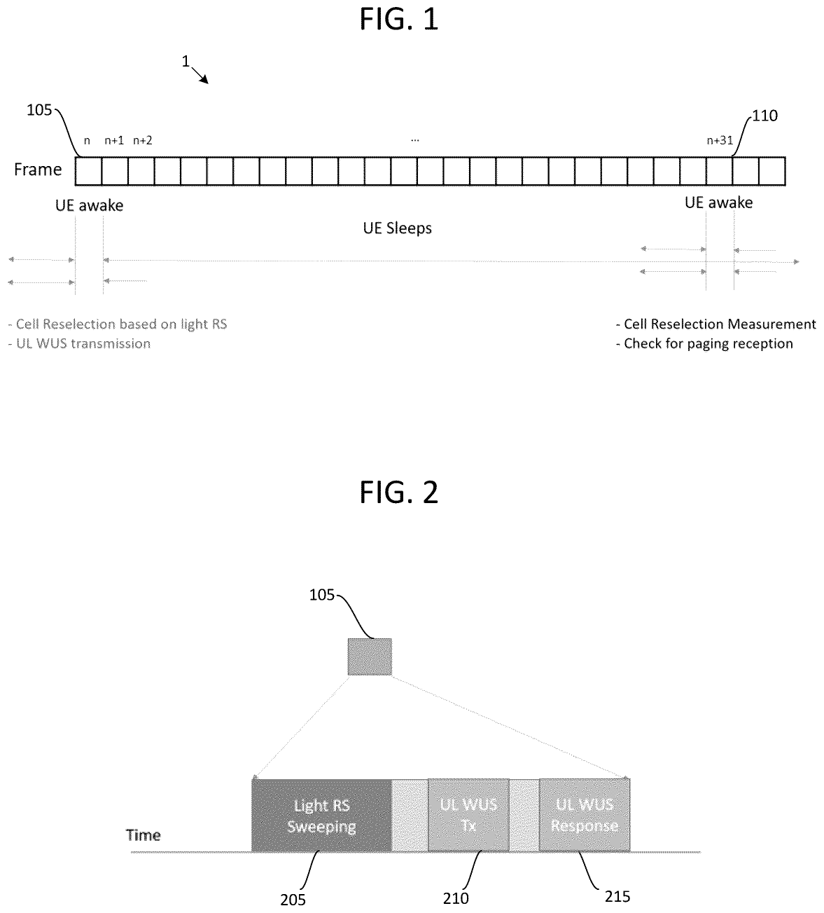

FIG. 1 is a diagram depicting a method for performing an on-demand wake-up procedure, according to some embodiments of the present disclosure.

Referring to FIG. 1, an example paging frame 100 is depicted. In some embodiments, a discontinuous reception (DRX) cycle of the UE may have a duration of 32 radio frames, and the UE checks for a paging message every 320 ms (e.g., the UE may be awake for checking paging reception in paging frame n and paging frame n+37). As shown in FIG. 1, in a first paging frame n 105, the UE may be awake/active to perform cell selection/reselection based on a reference signal received from a candidate cell (e.g., a network energy saving (NES) cells), check for paging reception, and transmit a wake-up signal (WUS) to a network node (e.g., a gNB) that provides the candidate cell based on a measurement of a reference signal received from the cell (e.g., measurements of performance characteristics of the reference signal). In some embodiments, the WUS may be an uplink (UL) WUS to trigger an on-demand message (e.g., an on-demand SSB/SIB1) in a second paging frame n+31 110 (e.g., the WUS is transmitted in a time slot which overlaps the existing paging frame to trigger on-demand SSB and SIB1 from neighboring cells). In some embodiments, the reference signal may be a light reference signal, which is described in more detail below in the context of FIG. 5. In some embodiments, the paging frame may be an existing downlink (DL) paging frame.

The UE may then go to idle mode (e.g., the UE may be inactive) from paging frame n+1 to paging frame n+30. For example, when the UE is inactive/idle, the UE may not perform cell reselection measurement nor check for paging reception. As used herein, a “cell reselection measurement” is a measurement of a reference signal received from a candidate cell. Upon receiving the on-demand message (e.g., on-demand SSB/SIB1) from the candidate cell which is triggered by the WUS, the UE may be awake (e.g., the UE may be active) to perform cell reselection measurement and check for paging reception in the second paging frame n+31 110 (e.g., the idle UE performs the legacy idle mode procedure in paging frame n+31). FIG. 2 is a diagram depicting an example WUS transmission, according to some embodiments of the present disclosure.

Referring to FIG. 2, a transmission in the first paging frame n 105 may include a downlink light reference signal sweeping 205, an UL WUS transmission 210, and an UL WUS response 215. In some embodiments, the light reference signal sweeping 205 may include information related to the measurement on the light reference signal. For example, the light reference signal sweeping 205 may include configuration for only sweeping one beam direction or a number of beam directions based on the light reference signal, instead of all of the 64 beam directions for beam sweeping in Frequency Range 2 (FR2) (e.g., the band from 24.25 GHz to 52.6 GHz, which may be referred to as FR2, and which is a band of frequencies focused on short-range, high data rate capabilities). In some embodiments, the UL WUS transmission 210 may include configuration to trigger the on-demand message in the second paging frame n+31. In some embodiments, the UL WUS response 215 may include configuration to send a confirmation message (e.g., an ACK/response message confirming that the WUS has been received by the gNB). In addition, the UL WUS response 215 may include information where a next on-demand message (e.g., a next SSB/SIB1 sent on demand) may be obtained e.g., a frequency and time resource expected to receive the next on-demand message.

The absence of repetition of reference signals transmitted in different beam directions for an inactive/idle UE to perform radio resource measurement (RRM) measurements may significantly reduce network energy, especially in FR2 (e.g., 64 SSB beams per candidate cell). In addition, the function of the light reference signal may include allowing the UE to become synchronized and performing measurements of signal strengths of candidate/neighboring cells. Therefore, the UE may down-select one candidate cell or a subset of candidate cells to trigger the on-demand message (e.g., legacy SSB sent on demand), and may further be able to perform more accurate RRM measurements of the on-demand message when there is only one candidate cell or a subset of candidate cells selected for inactive/idle UE mobility.

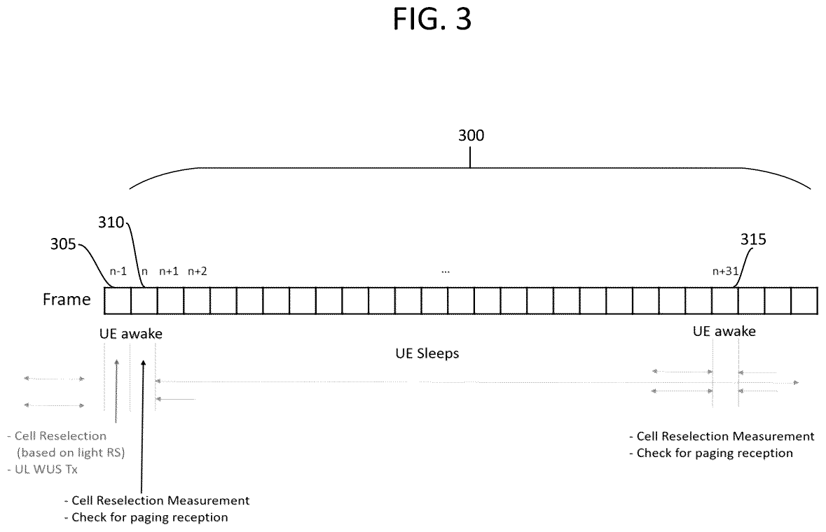

FIG. 3 is a diagram depicting a second method for performing an on-demand wake-up procedure, according to some embodiments of the present disclosure.

Referring to FIG. 3, an example paging frame 300 is depicted. In a first paging frame n−1 305, the UE may be awake/active to perform cell reselection based on a reference signal received from a candidate cell and transmit the WUS to the candidate cell based on the measurement of the cell reselection (e.g., the WUS is transmitted before the paging frame 300 or in a separated occasion). In some embodiments, the WUS may be an uplink (UL) WUS to trigger an on-demand message (e.g., an on-demand SSB/SIB1) in a second paging frame n 310 and/or a third paging frame n+31 315 (e.g., the WUS is transmitted in a time slot which is before the existing paging frame to trigger on-demand SSB and SIB1 from neighboring cells). In some embodiments, the reference signal may be a light reference signal, which is described in more detail in the context of FIG. 5. In some embodiments, the paging frame 300 may be an existing downlink (DL) paging frame.

In the second paging frame n 310, upon receiving the on-demand message (e.g., on-demand SSB/SIB1) from the candidate cell which is triggered by the WUS, the UE may be awake to perform cell reselection and check for paging reception. The UE may then go to idle mode (e.g., the UE may be inactive) from paging frame n+1 to paging frame n+30. For example, when the UE is inactive/idle, the UE may not perform cell reselection measurement nor check for paging reception. In some embodiments, the UE may also be awake to perform cell reselection measurement and check for paging reception in the third paging frame n+31 upon receiving the on-demand message from the candidate cell. The approach of transmitting the WUS before the existing paging frame or in a separated occasion (e.g., another paging frame) may reduce the latency in transmission.

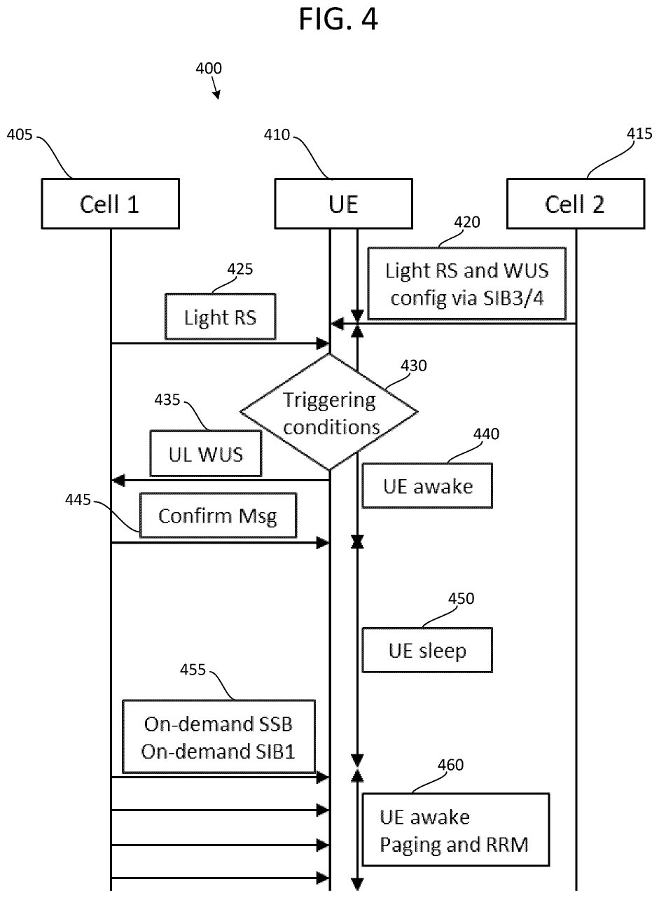

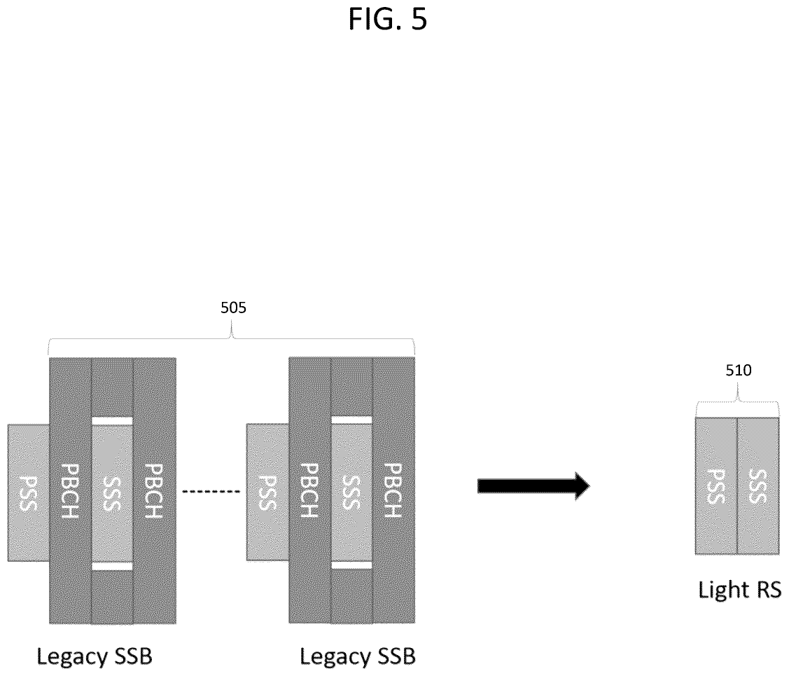

FIG. 4 is a flowchart depicting a method for performing an on-demand wake-up procedure, according to some embodiments of the present disclosure. Although FIG. 4 illustrates various operations in a method for performing an on-demand wake-up procedure, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIG. 4, a method 400 for performing the on-demand wake-up procedure may include one or more of the following operations. The UE 410 may receive configuration information (operation 420) from a second cell 415 (e.g., the cell that the UE 410 currently camps on) provided by a second network node (e.g., a gNB). In some embodiments, the UE 410 may be awake/active (operation 440) upon receiving the configuration information from the second network node. In some embodiments, the configuration information may include a configuration of the light reference signal and a configuration of the WUS. In some embodiments, the configuration of the WUS may include a slot in the paging frame (e.g., a DL paging frame) or a new defined frame for sending the WUS to neighboring cells. In some embodiments, the configuration information may be received via SIB3 and/or SIB4. In some embodiments, the UE 410 may be idle/inactive before receiving the configuration information from the second network node, and it may transition to active mode to receive the configuration information.

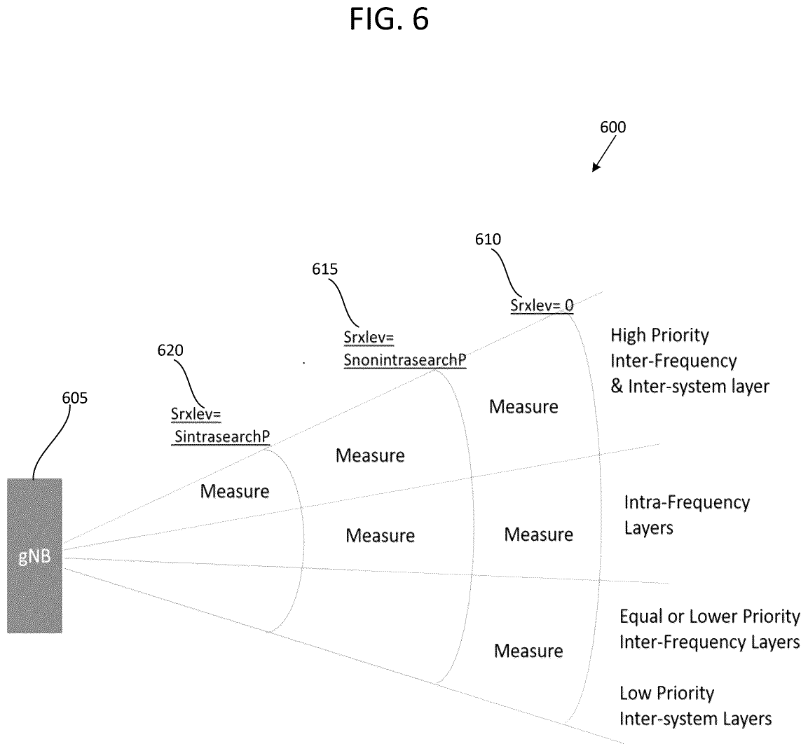

The UE 410 may receive a light reference signal (operation 425) from a first network node (e.g., a candidate gNB) which provides a first cell 405 (e.g., a candidate/neighboring cell for the UE 410). The UE 410 may determine whether to include an indication in the WUS to trigger an on-demand message based on trigger conditions (operation 430), which will be described in more details in FIG. 6. In some embodiments, the UE 410 may measure the light reference signal received from the first network node to determine whether to include an indication in the WUS to trigger the on-demand message based on the trigger conditions. For example, the UE 410 may perform cell selection/reselection to determine whether the candidate cell (e.g., the first cell 405) serves better radio conditions for the UE 410 than the camped cell (e.g., the second cell 415). In some embodiments, the light reference signal may include at least one of Primary Synchronization Signal (PSS) and/or Secondary Synchronization Signal (SSS). In some embodiments, the light reference signal may be received in a Light Reference Signal-based Radio Resource Measurement Timing Configuration (LMTC) window.

In some embodiments, conditions to trigger the WUS may also be signaled as part of WUS configuration via SIB1 from the first cell 405 (e.g., the current camped cell). For example, SIB signaling (e.g., SIB1), or radio resource control (RRC) of the current camped cell may configure the UE with specific WUS signals and specific light reference signals. For example, the WUS may be a specific contention-free msg1, e.g., a specific preamble combined with a dedicated resource object (RO) resource. In some embodiments, there are multiple WUSs, and each of the WUSs may have a different preamble and RO combination transmitted by the UE with different UL beams, in order to wake up the candidate cells in all possible beam directions. In some embodiments, the WUS may be an on-off keying (OOK) signal. In some embodiments, there is a pre-defined light reference signal-WUS resource mapping, such that during one active duration of DRX, the UE 410 may decode a set of DL light reference signal beams, and then in the same or next active duration of DRX, the UE 410 may transmit the WUS with the UL beam (e.g., QCL-TypeD) and the beam which received the light reference signal (e.g., a beam of the strongest reference signal received power (RSRP) received in the mapped corresponding to an occasion of the WUS transmission).

In some embodiments, a specific RACH preamble may rely on Zadoff-Chu (ZC) sequences. The parameters of the ZC sequence may be varied to create different preambles which are all orthogonal. For example, two orthogonal RACH preambles may have the same v (e.g., cyclic shifts of the random access preamble) but different u (e.g., ZC sequence index), or a different v but the same u. The UE 410 may be configured with a set of special preambles and/or ROs, where each of the ROs is associated with a unique UE identifier and a recommendation of one or more candidate cells and beam directions for the on-demand message transmissions. For example, an association between the preamble/RO and a recommendation of candidate cells and beam directions for the on-demand message transmissions may be indicated by a predefined set of values of u, v, and/or Ncs (e.g., cyclic shifts of ZC sequence). In some embodiments, transmission of the preamble may be either on a contention-based or contention-free RACH. For example, the UE 410 may transmit on a RACH corresponding to an SSB quasi-collocated with a specific candidate cell and beam direction that the UE 410 wants to utilize to perform paging and radio resource measurement (RRM). In some embodiments, the UE 410 may transmit on the first available and viable RACH resource as the WUS transmission.

In some embodiments, the RO may be a specific RO for the WUS, and the preamble may indicate which measurements the UE 410 needs to perform for paging and RRM. For example, UE may only need to measure a subset of beam directions of the on-demand message. The specific preamble and/or RO may give an indication of a time frame that the on-demand message is to be expected, e.g., a next DRX awake duration, the current DRX awake duration, and/or a nth DRX awake duration.

In some embodiments, the UE 410 may transmit one or more WUSs in a set of beams based on the previous DL light reference signal measurements from a set of candidate cells or transmission reception points (TRPs). For example, the UE 410 may transmit the WUS with one or more QCLed Type-D UL beams with QCL-Type D sources of the received set of DL light reference signal beams having a number of the strongest received RSRPs. For a potential candidate cell to detect the WUS from the UE 410, the candidate cell may perform blind detection without any optimal tuning of the reception beam, or perform the WUS reception with the beam corresponding to the selected Tx beam of WUS in a given WUS occasion, e.g., a particular frequency and time resource, according to a pre-defined light_RS-WUS resource mapping. In the case of performing the WUS reception with the beam corresponding to the selected Tx beam of WUS in the given WUS occasion, the UE 410 decodes a set of DL light reference signal beams, and then transmits the WUS with the QCLed Type-D UL beam with the received light reference beam of the strongest received RSRP in the mapped WUS occasion. Therefore, the candidate cell may determine the WUS reception beam based on the received signal in the WUS occasion.

In some embodiments, during the current or next connected mode DRX active duration (e.g., the UE 410 may be idle/inactive), the UE 410 may receive the on-demand message from the candidate cell as the legacy operation. The UE 410 may also receive a paging message from the current camped cell. Furthermore, the UE 410 may perform initial access in the current camped cell and/or small data transmissions. In addition, the UE 410 may also perform the cell selection/reselection measurements for inactive/idle mobility procedure.

In response to the measurement, the UE 410 may transmit a WUS to the first network node which provides the first cell 405 (operation 435). For example, the UE 410 identifies that the first cell 405 (e.g., the candidate cell) is the better cell to camp on than the second cell 415 (e.g., the current camped cell) based on the measurement on the light reference signal received from the first network node. In response to the identification (e.g., the UE 410 chooses the first cell 405 to connect to), the UE 410 may send the WUS to the first network node which provides network services in the first cell 405, so that the first network node that receives the WUS may be triggered to send an on-demand message to the UE 410 in a later paging frame. In some embodiments, the WUS may be transmitted in a first paging frame n, and the on-demand message may be triggered to be sent in a second paging frame n+31. In some embodiments, the WUS may be transmitted before the paging frame n−1 to trigger the on-demand message in a paging frame n. In some embodiments, the paging frame may be a DL paging frame. The UE may then receive a confirmation message of a receipt of the WUS from the first network node that provides the first cell 405 (operation 445). In some embodiments, the confirmation message may be an ACK/response message confirming that the WUS has been received by the first network node. In some embodiments, there may be a pre-configured resource (e.g., a Physical Downlink Control Channel (PDCCH) search space) a number of slots after the resource object where the first network node acknowledges that it has received the WUS (e.g., through a specific downlink control information (DCI) and/or a specific radio network temporary identifier (RNTI)). In some embodiments, the first network node may send the confirmation message to the (inactive/idle) UE via msgB (e.g., message 2 of random access channel (RACH), a combination of the random access response and the contention resolution identity).

In some embodiments, the UE 410 may be idle/inactive (e.g., it may go to sleep and cease constantly/periodically monitoring paging information) after receiving the confirmation message from the first network node (operation 450). For example, the (idle) UE 410 may perform a legacy idle mode procedure in the paging frame n+31.

The UE 410 may receive the on-demand message from the first network node (operation 455) to be active (e.g., to be connected to the first network node, or to camp on the first cell 405). In some embodiments, the on-demand message may be received via SSB and/or SIB1. In response to receiving the on-demand message, the UE 410 may be awake and monitor paging information and perform RRM (operation 460).

In some embodiments, in order to reduce UE power consumption as much as possible, an indication (e.g., an indication in SIB 1) may be sent indicating where the UE 410 may expect the on-demand message (e.g., SSB/SIB1) to be transmitted in the future time occasion (e.g., in which frequency resource and time resource where the on-demand message to be transmitted) once the WUS signal has been received by the first network node. In particular, the frequency resource may be the synchronization raster index where on-demand message is to be transmitted. The time resource may be the next Kth UE DRX awake occasion.

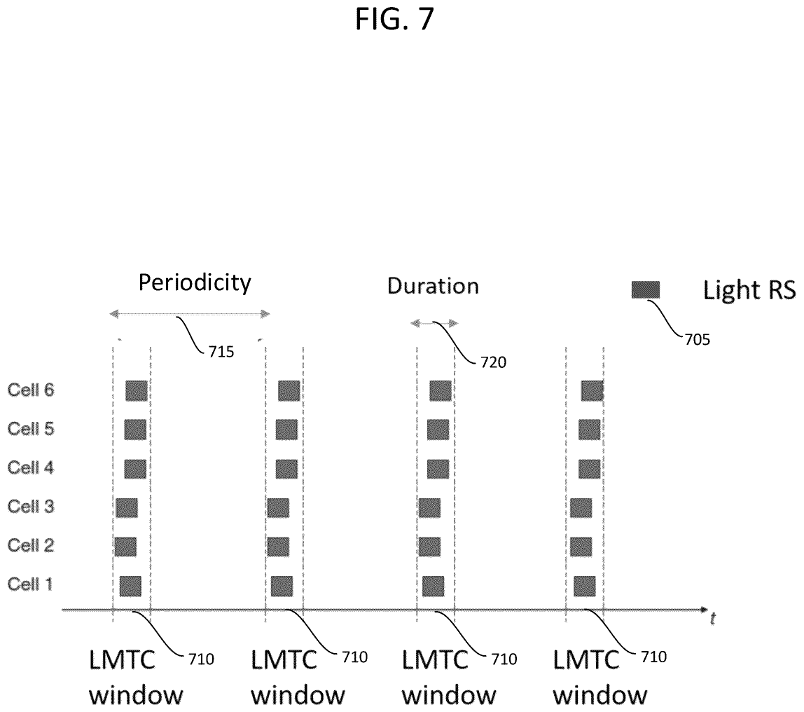

FIG. 7 is a diagram depicting an example light reference signal, according to some embodiments of the present disclosure.

Referring to FIG. 7, an example light reference signal 710 and an example legacy SSB 705 are depicted. In some embodiments, the light reference signal 710 may include Primary Synchronization Signal (PSS) and Secondary Synchronization Signal (SSS), which are utilized by the UE to obtain the cell identity and frame timing. In some embodiments, the legacy SSB 705 may include PSS and SSS packed with Primary Broadcast Channel (PBCH). For example, the light reference signal 710 may only include PSS and SSS to provide frequency and time synchronization of the candidate cell. The light reference signal 710 may allow the candidate cell to perform beam sweeping for the selected beams (e.g., the one beam direction or a subset of beam directions) for the UE to discover candidate cells in NES mode, instead of full beam sweeping (e.g., all 64 beam directions). Therefore, the UE only needs to identify a subset of potential good cells (e.g., cells that the light reference signal 710 transmitted from in the selected beam directions) before performing the RRM measurements. In some embodiments, PSS and SSS may occupy different symbols than their positions in the on-demand message (e.g., legacy SSB).

In some embodiments, the light reference signal 710 may be a reference signal in which PBCH and PBCH demodulation reference signal (DMRS) are removed from an existing SSB. In some embodiments, the light reference signal 710 may be a reference signal including only PSS, SSS, and PBCH DMRS. In some embodiments, the light reference signal 710 may be a known sequence occupying a full or partial orthogonal frequency-division multiplexing (OFDM) symbol that the UE may utilize to determine timing. In some embodiments, when the OFDM symbol includes an appropriately long cyclic prefix (CP) (e.g., a CP duration that may be longer than the maximum delay spread caused by the multipath channel), the UE may determine more accurate timing.

FIG. 6 is a diagram depicting example trigger conditions for measurements, according to some embodiments of the present disclosure.

Referring to FIG. 6, the trigger conditions for measurements (e.g., measurements to trigger the transmission of WUS) are depicted. In some embodiments, the UE may perform cell selection/reselection to determine whether a network node (e.g., a gNB 605) that provides connectivity to the UE has the best cell to camp on. In some embodiments, there are three thresholds set based on Srxlex (e.g., a cell selection RX (receive signal) level value (dBm), the synchronization signal-reference signal received power (SS-RSRP) measured by the UE): (1) a first threshold 610: Srxlev=0; (2) a second threshold 615: Srxlev=SnonIntraSearchP; and (3) a third threshold 620: Srxlev=SIntraSearchP. For example, the UE may perform measurements for performance characteristics (e.g., power, quality, RX level, and the like) of the light reference signal received from a candidate cell to trigger the WUS when Srxlev is bigger than zero. Otherwise, the UE may perform at least one of high priority inter-frequency measurement and inter-system measurement, intra-frequency measurement, equal or lower priority inter-frequency measurement and low priority inter-system measurement when Srxlev equals zero.

To reduce power consumption on the UE, the first threshold 610, the second threshold 615, and the third threshold 620 may trigger the WUS to ensure that UE does not perform measurement unnecessarily. In some embodiments, System Information from the current camped cell provides a list of frequencies where the UE should perform the WUS transmission and DL measurements. Therefore, the UE would not scan those channels that do not have the frequency in the list of frequencies. Furthermore, System Information from the current camped cell may also provide time domain occasions (e.g., a WUS transmitted before the DL paging frame) where the UE should perform the WUS transmission and DL measurements. In some embodiments, the time domain occasion may be indicated by a Kth UE discontinuous reception (DRX) awake occasion away from the current UE DRX awake occasion.

In some embodiments, the network may provide priorities of the frequencies for the UE to send the WUS and DL measurements in System Information or in dedicated RRC signaling when releasing an RRC connection. The measurements on lower priority frequencies may only be performed if (e.g., when) the UE cannot find a candidate cell with high quality and/or adequate signal level (e.g., required quality and signal level) on its higher priority frequencies.

In some embodiments, the network may also configure SIntraSearchP and SIntraSearchQ parameters. When RSRP of the current camped cell is above SIntraSearchP and Reference Signal Received Quality (RSRQ) of the current camped cell is above SIntraSearchQ, the UE may not send the WUS to wake up any candidate/neighboring cells. Only when these conditions (e.g., SIntraSearchP and/or SIntraSearchQ) are not fulfilled, the UE will start sending the WUS to wake up the candidate/neighboring cells.

In some embodiments, the UE may utilize Received Signal Strength Indicator (RSSI) or RSRP as thresholds to determine whether to send the WUS. For example, if (e.g., when) a measured RSSI or RSRP of the light reference signal is larger than a pre-configured threshold, the UE may send the WUS.

In some embodiments, RSRP of the current camped cell or RSRQ of the current camped cell may be referred to the representative RSRP/RSRQ value for the current camped cell, which indicates the strongest beam of the current camped cell.

In some embodiments, the criterion for cell selection/reselection may be met when Srxlev>0 and Squal>0, where Srxlev=Qrxlevmeas−(Qrxlevmin+Qrxlevminoffset)−Pcompensation−Qoffsettemp, and Squal=Qqualmeas−(Qqualmin+Qqualminoffset)−Qoffsettemp. The equation of Srxlev may verify the minimum signal level that the candidate/neighboring cell needs to provide to meet the criterion and is based on RSRP measurement (Qrxlevmeas), and the equation of Squal may verify a minimum RSRQ level of the candidate/neighboring cell (Qqualmeas). In some embodiments, the parameters in the above equations may be provided by the network in the System Information. For example, the System Information may include Qrxlevmin (e.g., minimum required RX level in the cell in dBm), Qrxlevminoffset (e.g., offset to the signaled Qrxlevmin taken into account in the Srxlev evaluation, as a result of a periodic search for a higher priority public land mobile network (PLMN) while camped normally in a visited PLMN), and Qoffsettemp (e.g., offset temporarily applied to the candidate/neighboring cell after a failure of connection establishment). When the measurement conditions (e.g., measurements for cell selection/reselection) are met, the UE may either trigger transmission of the WUS directly, or trigger measurement of the light reference signal and the transmission of the WUS.

In some embodiments, the UE may send the WUS and complete intra-frequency measurements for the candidate/neighboring cell if one of the following conditions is not satisfied: (1) a first condition: Srxlev>SintrasearchP, and (2) a second condition: Squal>SintrasearchQ. For example, the UE may not need to send the WUS and complete intra-frequency measurements for the candidate/neighboring cell when the current camped cell is relatively better. SIntrasearchP and SIntrasearchQ are both broadcast to the UE by SIB (e.g., SIB3/SIB4) via the current camped cell.

In some embodiments, the UE may always send the WUS and complete measurements for cell reselection towards a higher priority inter-frequency or inter-system layer.

In some embodiments, the UE may not need to send the WUS and complete measurements for cell reselection towards (1) an equal or lower priority inter-frequency layer or (2) a lower priority inter-frequency layer, if (e.g., when) both of the following conditions are satisfied: (1) a first condition: Srxlev>SnonintrasearchP, and (2) a second condition: Squal>SnonintrasearchQ.

FIG. 7 is a diagram depicting an example light reference signal transmitted in Light Reference Signal-based Radio Resource Measurement Timing Configuration (LMTC) windows, according to some embodiments of the present disclosure.

Referring to FIG. 7, candidate/neighboring cells (e.g., cell 1 to cell 6) may transmit their light reference signals 705 to the UE within the LMTC windows 710. In some embodiments, the LMTC windows 710 may be separated by a periodicity 715, in which the periodicity 715 may be calculated based on a period of time minus a duration 720 of the LMTC window 710. For example, the light reference signal 705 is transmitted utilizing the LMTC window, instead of a legacy SSB-based measurement timing configuration (SMTC) window. In some embodiments, compared to the SMTC window, the periodicity 715 between the LMTC windows 710 may be longer, and the duration 720 of the LMTC window 710 may be shorter.

The reference signals transmitted in the LMTC window may enhance efficiency (e.g., power consumption) of the cell selection/reselection, because LMTC is broadcast only from NES-capable gNBs in broadcast communications, which may be detected only by inactive/idle UEs, whereas the SMTC is still broadcast by non-NES gNBs.

In some embodiments, when the candidate/neighboring cells (e.g., cell 1 to cell 6) are in NES mode, the UE may measure the RSRP and RSSI of the light reference signal. Before performing the measurement, the UE may be configured with the measurement configuration via the current camped cell. For example, signaling of the LMTC may include a LMTC period and offset and a light reference signal occasion duration. In addition to the LMTC, the signaling within the LMTC window may include a measurement bandwidth and a set of transmission configuration indicator (TCI) states for each of the light reference signals, where the set of TCI states may indicate the subset of beam directions and signal the subset of beam directions to the UE.

In some embodiments, the bandwidth for the measurement of the light reference signal may be signaled to the UE in advance, in which the bandwidth for the measurement of the light reference signal may be different from the bandwidth for the measurement of legacy SSBs.

In some embodiments, the signaling within the LMTC window may include a list of neighboring cells (PCIDs) and a list of neighboring TRPs. TRP identification information for each of the TRPs may include parameters of the light reference signal for TRP identification.

In some embodiments, a measurement configuration of the light reference signal for the UE may include a RRC message under measObjectToAddMod as part of MeasObjectNR IE.

In some embodiments, MeasObjectNR may include following information:

| MeasObjectNR | |
|---|---|
| LightRS frequency | ARFCN-Value NR |
| LightRS SubcarrierSpacing | SubcarrierSpacing |
| lmtc1 | LMTC_1 |
| lmtc2 | LMTC_2 |

where LightRS Frequency may indicate the frequency of the light reference signal associated to MeasObjectNR, LightRS SubcarrierSpacing may be subcarrier spacing of the light reference signal, Imtc1 may be a primary measurement timing configuration which provides a timing offset and a duration for the light reference signal, and Imtc2 may be a secondary measurement timing configuration for the light reference signal corresponding to MeasObjectNR. In some embodiments, values of 15 or 30 (<6 GHz), or 120 kHz or 240 kHz (>6 GHz) of subcarrier spacing may be applicable.

In some embodiments, LMTC_1 field may be as follows:

```
LMTC SEQUENCE {
periodictyAndOfsset Choice {
  sf5 INTERGER (0..4)
  sf20 INTERGER (0..19)
  sf100 INTERGER (0..99)
    }
duration ENUMERATED {sf1, sf2, sf3, sf4, sf5}
}
```

where periodicity AndOffset may be periodicity and offset of the measurement window in which to receive light reference signal blocks, in which the periodicity and offset are given in number of subframes, and duration may be a duration of the measurement window to the light reference signal blocks, which is given in number of subframes.

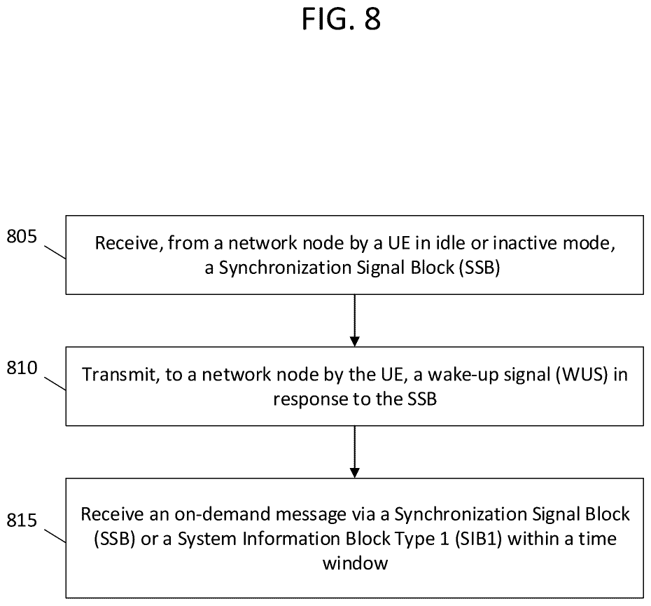

FIG. 8 is a flowchart depicting a method for performing an on-demand wake-up procedure, according to some embodiments of the present disclosure. Although FIG. 8 illustrates various operations in a method for performing an on-demand wake-up procedure, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

Referring to FIG. 8, at operation 805, the UE receives, from a network node, a Synchronization Signal Block (SSB). In some embodiments, the UE may be in idle or inactive mode. In some embodiments the SSB may be sent from a candidate network node.

At operation 810, the UE transmits, to a network node, the WUS in response to the SSB. For example, the UE may send the WUS to the network node (e.g., a candidate network node) based on the measurements on the SSB or the reference signal received from the network node. In some embodiments, transmitting the WUS in response to the SSB is based on a trigger condition. The trigger condition may be selected from among the group consisting of: a first trigger condition that either Srxlev is not higher than SintrasearchP or Squal is not higher than SintrasearchQ; a second trigger condition that a cell reselection is towards a higher priority inter-frequency or a higher priority inter-system layer; or a third trigger condition that Srxlev is higher than SnonintrasearchP and Squal is higher than SnonintrasearchQ.

In some embodiments, the WUS may be transmitted in a DL paging frame n to trigger the on-demand message in a DL paging frame n+31. In some embodiments, the WUS may be transmitted before the DL paging frame n−1 to trigger the on-demand message in a DL paging frame n.

In some embodiments, the UE may receive, from a first network node, configuration information. For example, the UE may be in idle or inactive mode before receiving the configuration information via SIB3/SIB4 from a cell that the UE currently camps on to initiate the on-demand wake-up procedure. In some embodiments, the confirmation information may include configuration information of the reference signal (e.g., a configuration of the light reference signal) and configuration information of the WUS (e.g., a configuration of the WUS), where the configuration information of the WUS may include a slot in the paging frame (e.g., a DL paging frame) or a new defined frame for sending a WUS to neighboring cells.

In some embodiments, the UE may receive, from the network node, the reference signal. In some embodiments, the UE may be in idle or inactive mode when receiving the reference signal from the network node. For example, the UE may receive the reference signal (e.g., a light reference signal) from candidate/neighboring cells (e.g., a cell that the network node is in) and determine whether to send a WUS to the candidate cell. The UE may measure the performance characteristics of the reference signal received from the network node to determine whether to include an indication (e.g., a slot to send the on-demand message) in the WUS to trigger the on-demand message based on the trigger condition (e.g., Srxlev). In some embodiments, the reference signal may be a light reference signal which includes Primary Synchronization Signal (PSS) and Secondary Synchronization Signal (SSS). In some embodiments, the reference signal may be received in the LMTC window.

In some embodiments, the UE receives, from the network node, a confirmation message of a receipt of the WUS. For example, the UE may go back to idle/inactive upon receiving the confirmation message from the candidate cell (e.g., the cell that the UE is going to connect to). In some embodiments, the confirmation message may be message 2 of random access channel (RACH).

At operation 815, the UE receives an on-demand message via a second SSB or a System Information Block Type 1 (SIB1) within a time window in a search space. For example, based on the indication in the WUS, the on-demand message may be sent in a DL paging frame n or a DL paging frame n+31 to wake up the UE. In some embodiments, the on-demand message may be sent within a specific time window, which indicates that the on-demand message is not sent periodically and is triggered by the WUS, so that the power consumption of the UE may be reduced. In some embodiments, a starting time and a duration of the time window may be indicated in the configuration information sent from the cell that the UE currently camps on (e.g., the first network node). In some embodiments, the UE may search in a search space (e.g., PDCCH search space) for the on-demand message. For example, the UE may receive the on-demand message in the search space. In some embodiments, the search space (e.g., frequency and time resources) may be indicated in an indication (e.g., in a previous SIB1 or in the confirmation message) which indicates where (e.g., in which frequency and time resources) the gNB will transmit future on-demand message (e.g., on-demand SSB/SIB1), so that the UE may expect the on-demand message to be transmitted in the future time occasion in the search space as indicated once the WUS has been received by the gNB. Therefore, the UE may reduce power consumption in searching the on-demand message. In some embodiments, the frequency resource for the on-demand message may be based on the synchronization raster index, where the on-demand message (e.g., SSB/SIB1) is to be transmitted, and the time resource may be the next Kth UE DRX awake occasion. In some embodiments, the search space is indicated in a previous on-demand message or the confirmation message. In some embodiments, time window may be indicated in the configuration information of WUS which includes a starting time and a duration of the time window. the UE may transition to active mode in response to receiving the on-demand message. For example, the UE may be active to perform cell selection/reselection and monitor paging information upon receiving the on-demand SSB/SIB1.

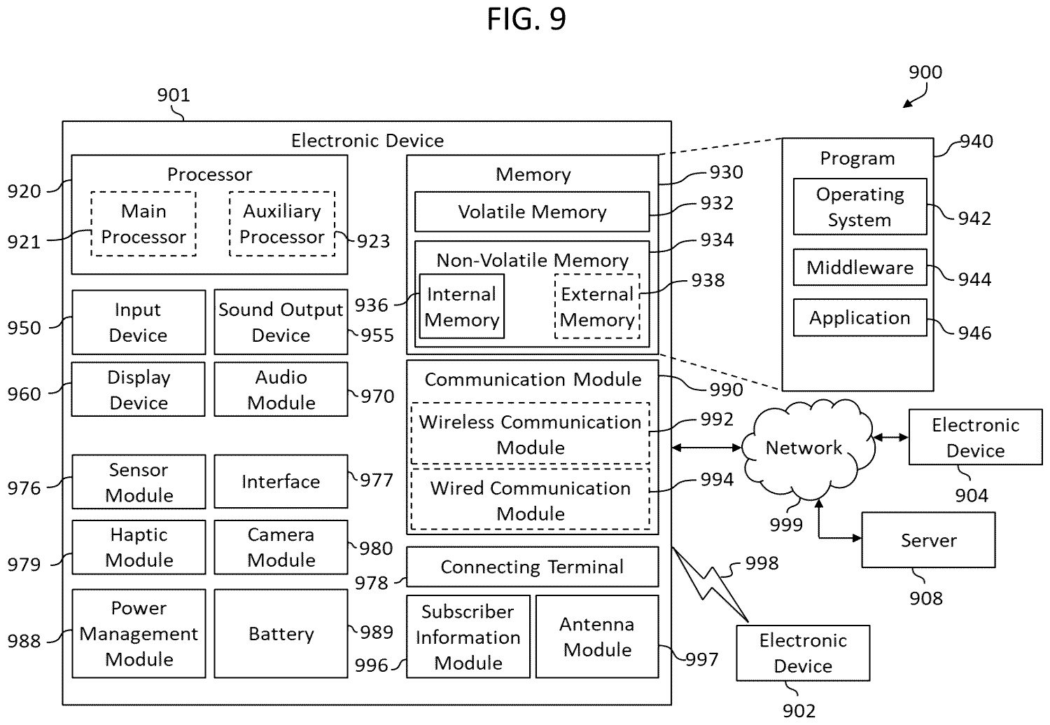

FIG. 9 is a block diagram of an electronic device in a network environment, according to some embodiments of the present disclosure.

Referring to FIG. 9, an electronic device 901 in a network environment 900 may communicate with an electronic device 902 via a first network 998 (e.g., a short-range wireless communication network), or with an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, and/or an antenna module 997. In one embodiment, at least one of the components (e.g., the display device 960 or the camera module 980) may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled to the processor 920, and may perform various data processing or computations.

As at least part of the data processing or computations, the processor 920 may load a command or data received from another component (e.g., the sensor module 976 or the communication module 990) in volatile memory 932, may process the command or the data stored in the volatile memory 932, and may store resulting data in non-volatile memory 934. The processor 920 may include a main processor 921 (e.g., a central processing unit or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or to execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990), as opposed to the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 960 may visually provide information to the outside (e.g., to a user) of the electronic device 901. The display device 960 may include, for example, a display, a hologram device, or a projector, and may include control circuitry to control a corresponding one of the display, hologram device, and projector. The display device 960 may include touch circuitry adapted to detect a touch, or may include sensor circuitry (e.g., a pressure sensor) adapted to measure the intensity of force incurred by the touch.

The audio module 970 may convert a sound into an electrical signal and vice versa. The audio module 970 may obtain the sound via the input device 950 or may output the sound via the sound output device 955 or a headphone of an external electronic device 902 directly (e.g., wired) or wirelessly coupled to the electronic device 901.

The sensor module 976 may detect an operational state (e.g., power or temperature) of the electronic device 901, or an environmental state (e.g., a state of a user) external to the electronic device 901. The sensor module 976 may then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 977 may support one or more specified protocols to be used for the electronic device 901 to be coupled to the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected to the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus, which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power that is supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell that is not rechargeable, a secondary cell that is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908), and may support performing communication via the established communication channel. The communication module 990 may include one or more communication processors that are operable independently from the processor 920 (e.g., the AP), and may support a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)), or via the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas. The communication module 990 (e.g., the wireless communication module 992) may select at least one of the one or more antennas appropriate for a communication scheme used in the communication network, such as the first network 998 or the second network 999. The signal or the power may then be transmitted or received between the communication module 990 and the external electronic device via the selected at least one antenna.

Commands or data may be transmitted or received between the electronic device 901 and the external electronic device 904 via the server 908 coupled to the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, cloud computing, distributed computing, or client-server computing technology may be used, for example.

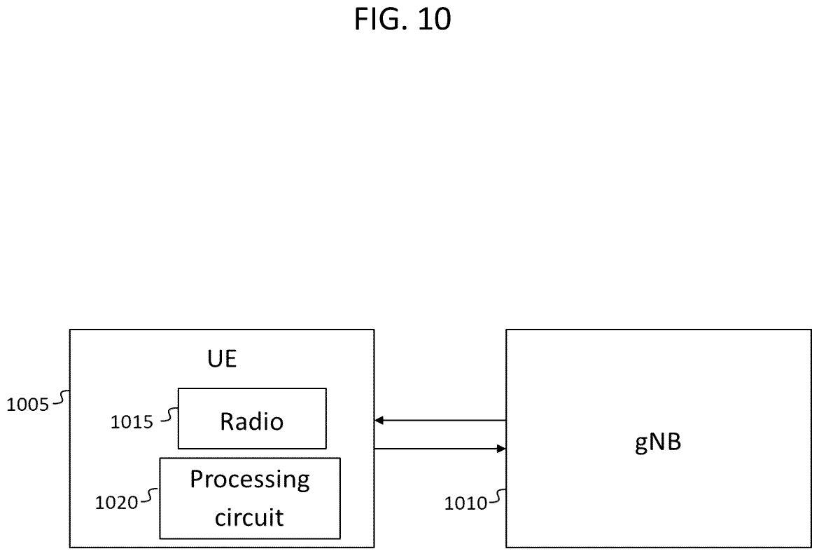

FIG. 10 shows a system including a UE 1005 and a gNB 1010, in communication with each other. The UE may include a radio 1015 and a processing circuit (or a means for processing) 1020, which may perform various methods disclosed herein, e.g., the method illustrated in FIG. 8. For example, the processing circuit 1020 may receive, via the radio 1015, transmissions from the network node (gNB) 1010, and the processing circuit 1020 may transmit, via the radio 1015, signals to the gNB 1010.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, with functional equivalents thereof to be included therein.

What is claimed is:

1. A method comprising:
receiving, from a network node by a UE in idle or inactive mode, a Synchronization Signal Block (SSB);
transmitting, to the network node by the UE in idle or inactive mode, a wake-up signal (WUS) in response to the SSB; and
receiving an on-demand message via a second SSB or a System Information Block Type 1 (SIB1) within a time window in a search space.

2. The method of claim 1, wherein the method further comprises:
receiving, from a second network node by the UE, configuration information of the WUS and configuration information of the reference signal.

3. The method of claim 1, wherein the WUS is an uplink (UL) wake-up signal transmitted in a time slot which is overlapped or before a downlink (DL) paging frame.

4. The method of claim 3, wherein the WUS is transmitted in a first DL paging frame n to trigger the on-demand message in a second DL paging frame n+31.

5. The method of claim 3, wherein the WUS is transmitted before the DL paging frame to trigger the on-demand message in a third DL paging frame n.

6. The method of claim 1, wherein the reference signal is a light reference signal which comprises at least one of Primary Synchronization Signal (PSS) or Secondary Synchronization Signal (SSS).

7. The method of claim 1, further comprising:
receiving, from the network node by the UE, a confirmation message of a receipt of the WUS.

8. The method of claim 7, wherein the search space is indicated in a previous on-demand message or the confirmation message.

9. The method of claim 1, wherein transmitting the WUS in response to the SSB is based on a trigger condition, wherein the trigger condition is selected from among the group consisting of:
a first trigger condition that either Srxlev is not higher than SintrasearchP or Squal is not higher than SintrasearchQ;
a second trigger condition that a cell reselection is towards a higher priority inter-frequency or a higher priority inter-system layer; or
a third trigger condition that Srxlev is higher than SnonintrasearchP and Squal is higher than SnonintrasearchQ.

10. The method of claim 2, wherein the time window is indicated in the configuration information of WUS which comprises a starting time and a duration of the time window.

11. A user equipment (UE) comprising a processing circuit, the processing circuit being configured to perform:
receiving, from a network node, a Synchronization Signal Block (SSB), wherein the UE is in idle or inactive mode;
transmitting, to the network node a wake-up signal (WUS) in response to the SSB, wherein the UE is in idle or inactive mode; and
receiving an on-demand message via a second SSB or a System Information Block Type 1 (SIB1) within a time window in a search space.

12. The UE of claim 11, wherein the processing circuit is further configured to perform:
receiving, from a second network node, configuration information of the WUS and configuration information of the reference signal.

13. The UE of claim 11, wherein the WUS is an uplink (UL) wake-up signal transmitted in a time slot which is overlapped or before a downlink (DL) paging frame.

14. The UE of claim 13, wherein the WUS is transmitted in a first DL paging frame n to trigger the on-demand message in a second DL paging frame n+31.

15. The UE of claim 13, wherein the WUS is transmitted before the DL paging frame to trigger the on-demand message in a third DL paging frame n.

16. The UE of claim 11, wherein the processing circuit is further configured to perform:
receiving, from the network node, a confirmation message of a receipt of the WUS.

17. The UE of claim 16, wherein the search space is indicated in a previous on-demand message or the confirmation message.

18. The UE of claim 11, wherein transmitting the WUS in response to the SSB is based on a trigger condition, wherein the trigger condition is selected from among the group consisting of:
a first trigger condition that either Srxlev is not higher than SintrasearchP or Squal is not higher than SintrasearchQ;
a second trigger condition that a cell reselection is towards a higher priority inter-frequency or a higher priority inter-system layer; or
a third trigger condition that Srxlev is higher than SnonintrasearchP and Squal is higher than SnonintrasearchQ.

19. The UE of claim 11, wherein the time window is indicated in the configuration information of WUS which comprises a starting time and a duration of the time window.

20. A system, comprising:
a user equipment (UE) configured to:
receive, from a network node, a Synchronization Signal Block (SSB), wherein the UE is in idle or inactive mode;
transmit, to a network node, a wake-up signal (WUS) in response to the SSB, wherein the UE is in idle or inactive mode; and
receive an on-demand message via a second SSB or a System Information Block Type 1 (SIB1) within a time window in a search space.
